(19) United States
(12) Patent Application Publication
(10) Pub. No.: US 2007/0261074 A1
(43) Pub. Date: Nov. 8, 2007

(54) Broadcast receiver and method for processing broadcast data

(76) Inventor: Chang Sik Yun, Daejeon (KR)

Correspondence Address: MCKENNA LONG & ALDRIDGE LLP;Song K. Jung, 1900 K Street, N.W., Washington, DC, 20006, US

(21) Appl. No.: 11/790,271

(22) Filed: Apr. 24, 2007

(30) Foreign Application Priority Data
Apr. 25, 2006 (KR) 10-2006-0037396

(51) Int. Cl. H04H 9/00; H04N 7/16

(52) U.S. Cl. 725/20; 725/22; 725/19

(57) ABSTRACT

A broadcast receiver and a method for processing broadcast data are disclosed. A method for processing a broadcast signal including a table of a Program Specific Information (PSI) or Program and System Information Protocol (PSIP) includes: receiving a broadcast signal including identifier (ID) information for identifying broadcast advertisement data; detecting the ID information from the received broadcast signal; and controlling the broadcast advertisement data whether or not to be stored in a memory the base on the detected ID information.

This application claims the benefit of Korean Patent Application No. 10-2006-0037396, filed on Apr. 25, 2006, which is hereby incorporated by reference as if fully set forth herein.

### BACKGROUND

1. Field of Disclosure

The present disclosure relates to a broadcast receiver and a method for processing broadcast data, and more particularly to a method for processing broadcast data including ID information for identifying a broadcast program and broadcast advertisement data using a table contained in a PSI or PSIP, and a broadcast receiver for the same.

2. Discussion of the Related Art

There are a variety of digital broadcast protocols, for example, a Program and System Information Protocol (PSIP), etc.

The PSIP performs parsing of messages encoded by an MPEG-2 system (e.g., ISO/IEC 13818-1 system), and provides a variety of information associated with broadcast programs. The PSIP is basically similar to a Program and System information (PSI) of the MPEG system.

The PSIP can transmit/receive Audio/Video (A/V) data configured in the form of MPEG-2 video data and AC-3 audio format. The PSIP includes a variety of tables capable of transmitting information of channels of individual broadcast stations and each program of the channel, etc. The tables are distributed to several sections, and are then transmitted to a desired destination.

According to the PSIP protocol, a broadcast receiver such as a digital TV can support a main function for selecting a desired channel and providing A/V services of a desired broadcast program over the selected channel or an additional function for providing EPG (Electronic Program Guide) data of the broadcast program.

Recently, a memory card receiver or a Hard Disc Drive (HDD) is embedded in the above-mentioned broadcast receiver such as the digital TV, such that a variety of functions can be implemented by the broadcast receiver.

For example, a Personal Video Recording (PVR) function enables a user to freely record his or her viewing digital content data in the HDD contained in the broadcast receiver such as the digital TV, or enables the user to freely reproduce the recorded data as necessary.

### SUMMARY

Accordingly, the present implementation is directed to a broadcast receiver and a method for processing broadcast data that substantially obviate one or more problems due to limitations and disadvantages of the related art.

An object of the present implementation is to provide a method for processing broadcast data including ID information for identifying a broadcast program and broadcast advertisement data using a table contained in a specific PSI or PSIP, and a broadcast receiver for use in the same.

Another object of the present implementation is to provide a method for receiving broadcast data including specific information capable of more precisely defining broadcast advertisement type information using a table of a specific PSI/PSIP, and controlling the received broadcast data, and a broadcast receiver for processing broadcast advertisement data.

A still another object of the present implementation is to provide a method for controlling broadcast advertisement data in a digital broadcast system, which automatically excludes broadcast advertisement data while a broadcast program of a specific time zone is recorded, extracts only the broadcast program, and stores the extracted broadcast program, and a broadcast receiver for processing the broadcast advertisement data.

Additional advantages, objects, and features of the implementation will be set forth in part in the description which follows and in part will become apparent to those having ordinary skill in the art upon examination of the following or may be learned from practice of the implementation. The objectives and other advantages of the implementation may be realized and attained by the structure particularly pointed out in the written description and claims hereof as well as the appended drawings.

To achieve these objects and other advantages and in accordance with the purpose of the implementation, as embodied and broadly described herein, a method for processing a broadcast signal including a table of a Program Specific Information (PSI) or Program and System Information Protocol (PSIP) comprising: receiving a broadcast signal including identifier (ID) information for identifying broadcast advertisement data; detecting the ID information from the received broadcast signal; and controlling the broadcast advertisement data whether or not to be stored in a memory the base on the detected ID information.

For example, the ID information is extracted from either a content-type field or a descriptor of the PSI and PSIP tables.

For example, the content-type field including the ID information is transmitted along with a PCR_PID field.

For example, the content-type field including the ID information is transmitted along with at least one of a “major_channel_number” field, a “minor_channel_number” field, a “carrier_frequency” field, a “program_number” field, and a “source_id” field.

In another aspect of the present implementation, there is provide a method for processing a broadcast signal including a table of a Program Specific Information (PSI) or Program and System Information Protocol (PSIP) comprising: receiving a broadcast signal including both identifier (ID) information for identifying broadcast advertisement data and broadcast advertisement type information for defining type information of the broadcast advertisement data; detecting the ID information from the broadcast advertisement type information from the received broadcast signal; and controlling specific-type broadcast advertisement data whether or not to be stored in a memory the base on the detected ID information and the broadcast advertisement type information.

For example, the ID information and the broadcast advertisement type information are extracted from either a content-type field or a descriptor of the PSI and PSIP tables.

For example, the content-type field including the ID information and the broadcast advertisement type information is transmitted along with a PCR_PID field.

For example, the content-type field including the ID information and the broadcast advertisement type information is transmitted along with at least one of a “major_channel_number” field, a “minor_channel_number” field, a “carrier_frequency” field, a “program_number” field, and a “source_id” field.

For example, the specific type is established by a user.

In yet another aspect of the present implementation, there is provided a broadcast receiver comprising: a tuner for receiving a broadcast signal including identifier (ID) information for identifying broadcast advertisement data; a detector for extracting the ID information from the received broadcast signal; and a controller for allowing the broadcast advertisement data whether or not to be stored in a memory the base on the detected ID information.

For example, the detector extracts the ID information from either a content-type field or a descriptor of a Program Specific Information (PSI) and Program and System Information Protocol (PSIP) tables.

For example, the controller allows specific-type broadcast advertisement data established by a user to be stored in the memory.

In yet another aspect of the present implementation, there is provided a broadcast receiver comprising: a tuner for receiving a broadcast signal including identifier (ID) information for identifying broadcast advertisement data and broadcast advertisement type information for defining type information of the broadcast advertisement data; a detector for extracting the ID information and the broadcast advertisement type information from the received broadcast signal; and a controller for allowing the broadcast advertisement data whether or not to be stored in a memory the base on the detected ID information and broadcast advertisement type information.

For example, the detector extracts the ID information and the broadcast advertisement type information from either a content-type field or a descriptor of a Program Specific Information (PSI) or Program and System Information Protocol (PSIP) table.

For example, the controller allows specific-type broadcast advertisement data established by a user to be stored in the memory.

It is to be understood that both the foregoing general description and the following detailed description of the present implementation are exemplary and explanatory and are intended to provide further explanation of the implementation as claimed.

### BRIEF DESCRIPTION OF THE DRAWINGS

The accompanying drawings, which are included to provide a further understanding of the present implementation and are incorporated in and constitute a part of this application, illustrate example(s) of the implementation and together with the description serve to explain the principle of the implementation. In the drawings:

FIG. 1 shows an exemplary table of a Program Map Table (PMT) syntax;

FIG. 2A shows an exemplary table of a content_type field;

FIG. 2B shows another exemplary table of the content_type field;

FIG. 3 shows an exemplary table of a content_type descriptor;

FIG. 4A shows an exemplary table of a Virtual Channel Table (VCT) syntax;

FIGS. 4B˜4C are flow charts illustrating methods for processing broadcast data by a transmission;

FIG. 5 is a block diagram illustrating a broadcast receiver for receiving a Program Map Table (PMT) or Virtual Channel Table (VCT) of a PSI/PSIP (Program Specific Information/Program and System Information Protocol), and processing the received PMT or VCT; and

FIG. 6 is a flow chart illustrating a method for controlling a broadcast receiver for receiving a Program Map Table (PMT) or Virtual Channel Table (VCT) of a PSI/PSIP (Program Specific Information/Program and System Information Protocol), and processing the received PMT or VCT.

### DETAILED DESCRIPTION

Reference will now be made in detail to the preferred examples of the present implementation, examples of which are illustrated in the accompanying drawings. Wherever possible, the same reference numbers will be used throughout the drawings to refer to the same or like parts.

Prior to describing the present implementation, the present implementation will hereinafter be described with reference to the following first to fourth preferred examples. The first preferred example provides a method for configuring a PMT syntax. The second preferred example provides a method for configuring a VCT syntax. The third preferred example provides a method for receiving a PMT or VCT and processing the received PMT or VCT. The fourth preferred example provides a method for controlling broadcast advertisement data by a broadcast receiver.

First Preferred Implementation

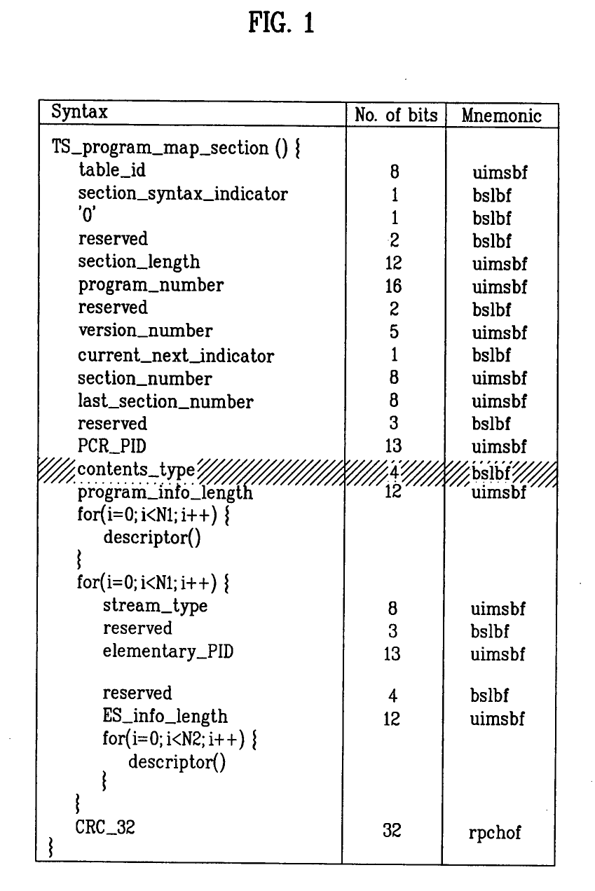

FIG. 1 shows an exemplary table of a Program Map Table (PMT) syntax according to the present implementation.

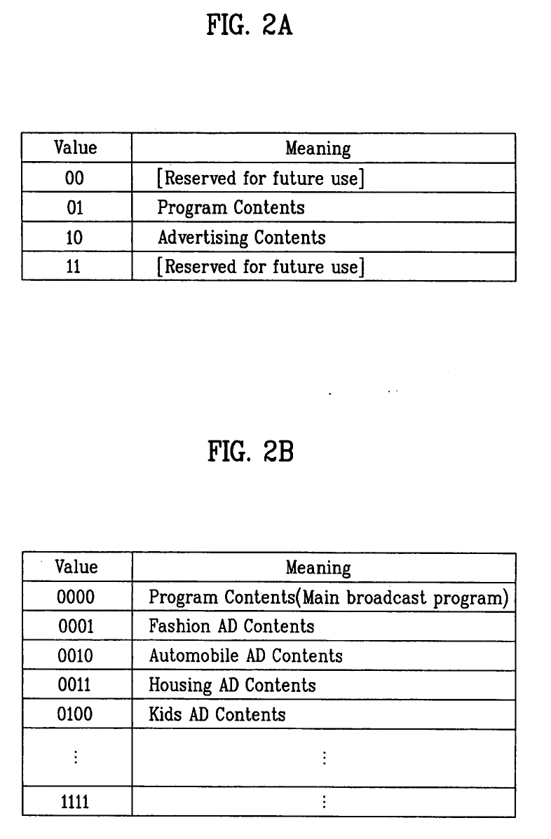

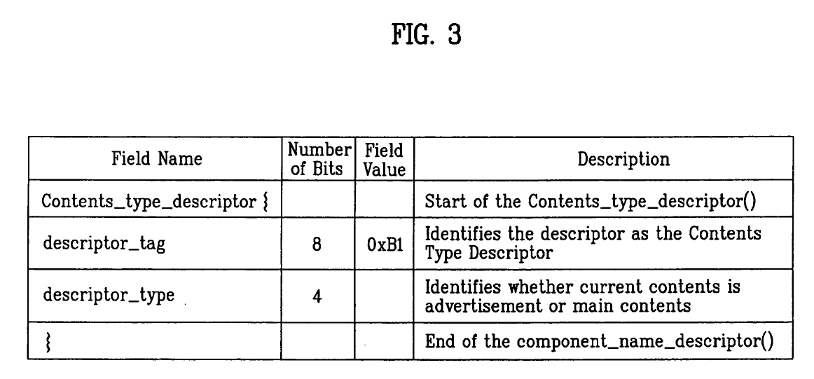

FIG. 2A shows an exemplary table of a content_type field according to the present implementation.

FIG. 2B shows another exemplary table of the content_type field according to the present implementation.

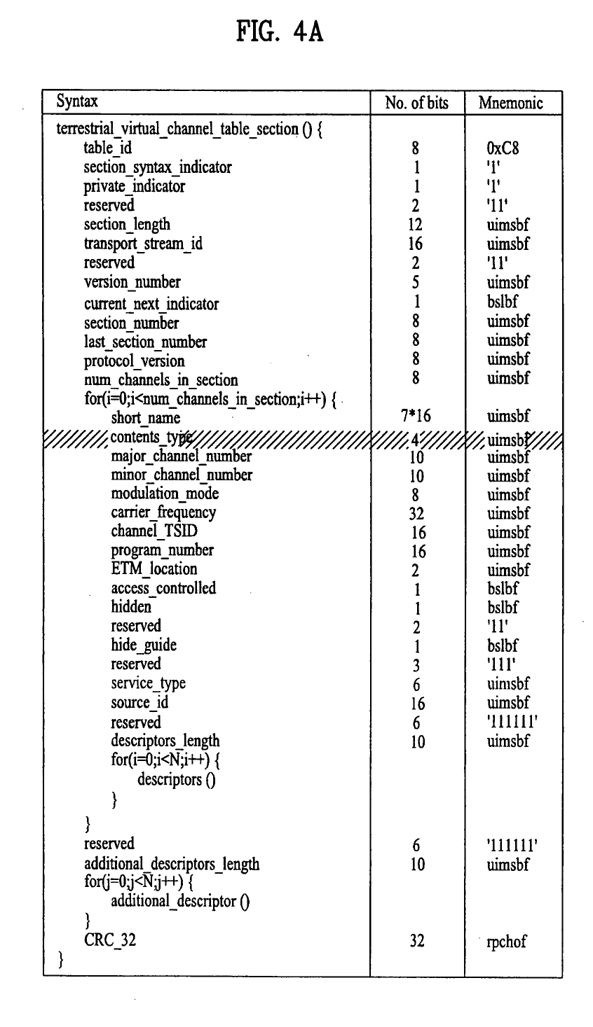

FIG. 3 shows an exemplary table of a content_type descriptor according to the present implementation.

A method for constructing the PMT syntax according to the present implementation will hereinafter be described with reference to FIGS. 1, 2A, 2B, and 3.

The PMT (Program Map Table) is indicative of a table for loading information of a program capable of being contained in each physical channel. There are a variety of PMTs, for example, “audio_pid”, “video_pid”, “teletext_pid”, and “pcr_pid” information, etc. The broadcast receiver can configure a table using the above-mentioned PMTs. Therefore the PMT table indicates program information of broadcast programs of individual channels.

In the meantime, a new PMT is received in the broadcast receiver within a predetermined time of 400 ms. if the PMT loading the program information includes specific information, the advertisement processing method can be effectively implemented. In this case, the specific information indicates whether currently-broadcast digital content data is a broadcast advertisement program, and indicates a detailed type of the broadcast advertisement program.

Particularly, the present implementation is characterized in that it employs the PMT periodically received within the time of 400 ms.

In a PAT (Program Association Table) in which a packet ID is defined as “0x00”, a basic PMT transmission method performs parsing of the packet ID for transmitting the PMT, such that it can receive the PMT.

The PAT is received at intervals of a predetermined period, such that it can indicate whether a current broadcast program is a broadcast advertisement program using the following two methods when a main broadcast program is changed to a broadcast advertisement program.

On the contrary, the present implementation can also be used when the broadcast advertisement program is changed to the main broadcast program.

A first method from among the two methods is a method for employing a reserved field contained in the PMT, and a detailed description thereof will hereinafter be described.

The PMT includes a plurality of reserved fields. For the convenience of description, it should be noted that a specific reserved field from among several reserved fields is defined as a “content_type” field, as shown in FIG. 1. The specific reserved field acting as the “content_type” field is the next field of the “PCR PID” field.

If 2 bits are assigned to the “content_type” field, the “content_type” field is used as a field for identifying the main broadcast program and the broadcast advertisement program, as shown in FIG. 2A.

For example, if the “content_type” field has the value of “01”, it indicates that a current broadcast program is a main broadcast program (i.e., program contents).

If the “content_type” field has the value of “10”, it indicates that a current broadcast program is a broadcast advertisement program (i.e., advertising contents).

In the meantime, if 4 bits are assigned to the “content_type” field, the “content_type” field can identify the main broadcast program and the broadcast advertisement program, and can more precisely identify type information of the broadcast advertisement program.

For example, if the content_type field has the value of “0000”, it indicates that a current broadcast program is the main broadcast program (i.e., program contents).

If the “content_type” field has the value of “0001”, it indicates that a current broadcast program is a fashion advertisement program (i.e., Fashion AD contents). If the “content_type” field has the value of “0010”, it indicates that a current broadcast program is automobile AD content data (i.e., automobile AD contents).

If the “content_type” field has the value of “0011”, it indicates that a current broadcast program is housing AD content data (i.e., housing AD contents). If the “content_type” field has the value of “0100”, it indicates that a current broadcast program is Kids AD content data (i.e., Kids AD contents).

As shown in FIG. 2B, the “content_type” field table can be defined to have a predetermined level according to contents of the broadcast advertisement program, instead of defining type information of the broadcast advertisement program.

For example, if the “content_type” field has the values from 0001 to 0011, the broadcast advertisement programs are classified according to ages of TV-viewing users. If the “content_type” field has the values from 0100 to 0110, the broadcast advertisement programs are classified according to the degree of public benefits.

In this way, different grades are assigned to similar advertisement messages, such that a variety of user interests can be maximally satisfied by the “content_type” field.

In the meantime, a second method from among the above-mentioned two methods is a method for newly defining a descriptor contained in the PMT, and a detailed description thereof will hereinafter be described.

As shown in FIG. 3, a defined descriptor is newly defined in the descriptor field of the PMT.

The “content_type_descriptor” field indicates the beginning of a descriptor for defining content type information. The “descriptor_tag” field indicates that a corresponding descriptor is identified by a “content_type descriptor” field. For example, the “descriptor_tag” field may have the value of “0xB1”.

The “descriptor_type” field can identify whether a current broadcast program is a main broadcast program or broadcast advertisement program. If 2 bits are assigned to the “descriptor_type” field, the field may have the values and meanings shown in FIG. 2A.

In the meantime, if 4 bits are assigned to the “descriptor_type” field, the field may have the values and meanings shown in FIG. 2B.

Second Preferred Implementation

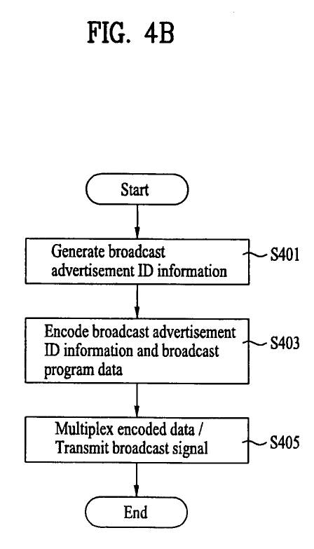

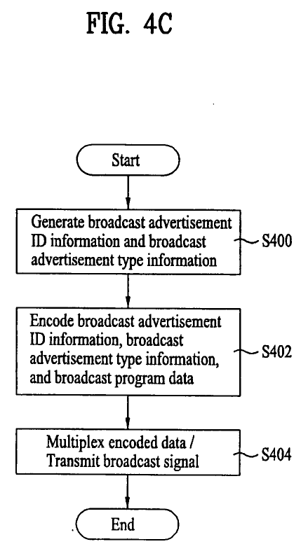

FIG. 4 shows a Virtual Channel Table (VCT) syntax according to the present implementation.

A method for constructing the VCT syntax according to the present implementation will hereinafter be described with reference to FIG. 4 and FIGS. 2A, 2B, and 3.

According to the second preferred example, a field for defining a broadcast advertisement program in the VCT is defined in a reserved field or descriptor, in the same manner as in the first preferred example in which the field for defining the broadcast advertisement program in the PMT is defined in a reserved field or descriptor.

The VCT is indicative of a table for loading information of a program capable of being contained in each physical channel. The VCT may be divided into 256 sections.

A single section may load several virtual channel information pieces. However, single virtual channel information is not divided into at least two sections.

There are a variety of bitstream syntaxes of a terrestrial-broadcast VCT, for example, a transport stream ID, a channel number, a short_name, a carrier_frequency, and a program_number, etc. Additional information is contained in a VCT descriptor. The channel number includes “major_channel_number” and “minor_channel_number” information.

In this case, the “program_number” information indicates connection to a virtual channel in which an MPEG-2 PAT (Program Association Table) and a PMT are defined. The “program_number” information is equal to a program number contained in the PAT/PMT.

In this case, the PAT describes constituent elements of each program having a unique program number. The PMT indicates the PID of the transport packet for transmitting the PMT. The PMT describes the PID list and additional information of a transport packet via which the program ID number and A/V bit-streams of the program are transmitted.

Differently from the PMT, information of all the virtual channels contained in each physical channel is transmitted via only one VCT.

Similar to the above-mentioned PMT, the VCT is received at intervals of a predetermined period.

If the VCT loading the program information includes specific information, the advertisement processing method can be effectively implemented. In this case, the specific information indicates whether currently-broadcast digital content data is a broadcast advertisement program, and indicates a detailed type of the broadcast advertisement program.

The second preferred example of the present implementation is characterized in that it employs the VCT received at intervals of a predetermined period.

The VCT is received at intervals of a predetermined period, such that it can indicate whether a current broadcast program is a broadcast advertisement program using the following two methods when a main broadcast program is changed to a broadcast advertisement program.

On the contrary, the second preferred example of the present implementation can also be used when the broadcast advertisement program is changed to the main broadcast program.

A first method from among the two methods is a method for employing a reserved field contained in the VCT, and a detailed description thereof will hereinafter be described.

According to the VCT structure, virtual channel information contained in a single physical channel turns a loop contained in the table, and is transmitted to a destination.

As shown in FIG. 4, a plurality of reserved fields are located under the “for loop” information indicating each virtual channel information.

For the convenience of description, it should be noted that a specific reserved field from among several reserved fields is defined as a “content_type” field, as shown in FIG. 4. In this case, the specific reserved field acting as the “content_type” field is the next field of the “short_name” field indicating channel names of individual channels.

If 2 bits are assigned to the “content_type” field, the definition of FIG. 2a is established. If 4 bits are assigned to the “content_type” field, the definition of FIG. 2B is established.

The detailed description of FIGS. 2A˜2B has already been fully described in the first preferred example of the present implementation, such that detailed descriptions of FIGS. 2A˜2B will herein be omitted for the convenience of description.

A second method from among the two methods is a method for newly defining a descriptor contained in the VCT, and a detailed description thereof will hereinafter be described.

As shown in FIG. 3, the second method is designed to newly design a defined descriptor in a descriptor field contained in the PMT.

Detailed description of individual fields has already been fully described in the first preferred example, such that detailed descriptions of FIGS. 2A˜2B will herein be omitted for the convenience of description.

Differently from the PMT for transmitting program information of a virtual channel of a single physical cannel, the VCT transmits overall channel information over a single physical channel. As a result, the second preferred example can define the descriptor of FIG. 3 in the last “descriptor” field contained in the “for loop” field for transmitting each virtual channel information.

FIG. 4A shows a Virtual Channel Table (VCT) syntax according to the present implementation.

FIGS. 4B˜4C are flow charts illustrating methods for processing broadcast data by a transmission end according to the present implementation.

Referring to FIG. 4B, ID information for identifying broadcast advertisement data is contained in the VCT or PMT, such that the resultant ID information is generated at step S401. The broadcast advertisement ID information and the broadcast program data are encoded by the MPEG-2 method at step S403. The encoded data is multiplexed, such that the multiplexed data is transmitted in the form of a broadcast signal at step S405.

Referring to FIG. 4C, according to another method for transmitting a broadcast signal by the transmission end, the ID information for identifying broadcast advertisement data and broadcast advertisement type information for defining the broadcast advertisement type are contained in the VCT or PMT, such that the resultant data is generated at step S400. The broadcast advertisement ID information, the broadcast advertisement type information, and the broadcast program data are encoded by the MPEG-2 method at step S402. The encoded data is multiplexed, such that the multiplexed data is transmitted in the form of a broadcast signal at step S404.

Third Preferred Implementation

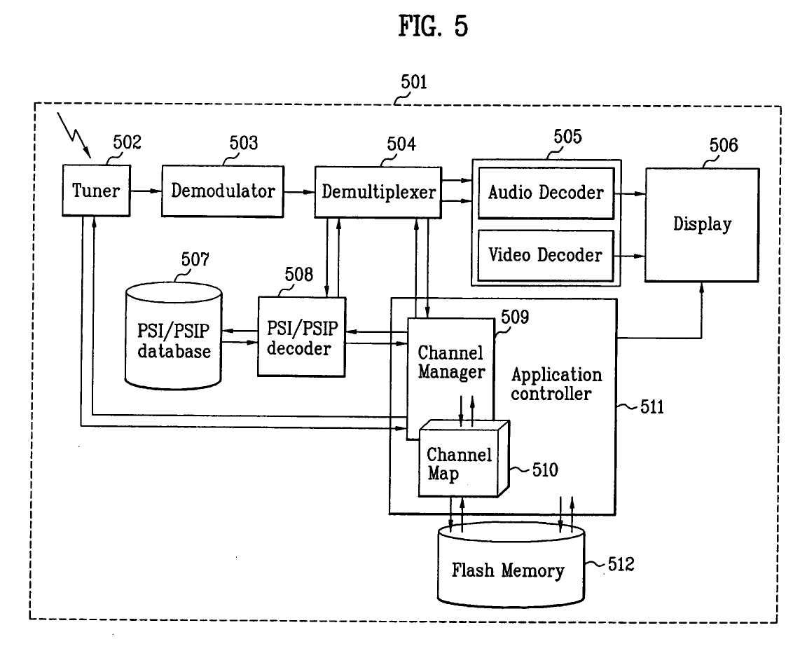

FIG. 5 is a block diagram illustrating a broadcast receiver for receiving a Program Map Table (PMT) or Virtual Channel Table (VCT) of a PSI/PSIP (Program Specific Information/Program and System Information Protocol), and processing the received PMT or VCT according to the present implementation.

A broadcast receiver for receiving/processing the PMT or VCT will hereinafter be described with reference to FIG. 5 and FIGS. 1˜4.

Referring to FIG. 5, the broadcast receiver 501 includes a tuner 502, a demodulator 503, a demultiplexer 504, an A/V decoder 505, a display 506, a PSI/PSIP database 507, a PSI/PSIP decoder 508, a channel manager 509, a channel map 510, an application controller 511, and a flash memory 512.

The broadcast receiver 501 may be set to a digital TV (DTV) capable of receiving digital broadcast data.

The tuner 502 can receive a digital broadcast signal including the PSI/PSIP table.

Particularly, the PSI/PSIP table includes a PMT (Program Map Table) and a Virtual Channel Table (VCT).

In the meantime, the tuner 502 can be controlled by the channel manager 509.

The tuner 502 records the resultant data of the received digital broadcast signal in the channel manager 509.

The demodulator 503 demodulates the signal tuned by the tuner 502 into a VSB/EVSB (Vestigial Side Band/Enhanced Vestigial Side Band).

The demultiplexer 504 demultiplexes the signal demodulated by the demodulator 503 into audio data, video data, and PSI/PSIP table data.

The demultiplexing of the audio and video data can be controlled by the channel manager 509. The demultiplexing of the PSI/PSIP table data can be controlled by the PSI/PSIP decoder 508.

The demultiplexed PSI/PSIP table is transmitted to the PSI/PSIP decoder 508. The demultiplexed audio and video data is transmitted to the A/V decoder 505. The A/V decoder 508 decodes the received data.

The PSI/PSIP decoder 508 performs parsing of the PSI/PSIP section, reads the remaining actual section data which has not been section-filtered by the demultiplexer 504, and records the read data in the PSI/PSIP database 507.

The channel manager 509 transmits a request for receiving a channel-associated information table by referring to the channel map 510, and receives the response to the request.

In this case, the PSI/PSIP decoder 508 controls the demultiplexing of the channel-associated information table, and transmits the A/V PID list to the channel manager 509. The channel manager 509 directly controls the demultiplexer 504 using the transmitted A/V PID list, thereby controlling the A/V decoder 505.

The application controller 511 controls a Graphical User Interface (GUI) for displaying status information of the broadcast receiver system on the OSD (On Screen Display).

Particularly, according to the third preferred example of the present implementation, the demultiplexer 504 demultiplexes the PMT and VCT, and transmits the demultiplexed result to the PSI/PSIP decoder 508.

The PMT and VCT according to the third preferred example of the present implementation can be easily understood by the first and second preferred examples. The PMT and VCT of the first and second preferred examples are equal to those of the third preferred example of the present implementation.

In this case, based on the PMT and VCT, the application controller 511 can determine whether a broadcast program received via the tuner 502 or a broadcast program pre-stored in a storage unit (not shown) is indicative of a broadcast advertisement program, and can determine a detailed broadcast advertisement program type.

Therefore, upon receiving a user request, the application controller 511 controls only the main broadcast program to be displayed, and can control the broadcast advertisement program not to be displayed.

If the broadcast receiver 501 has a recording function, the application controller 511 stores only the main broadcast program, and can prevent the broadcast advertisement program from being stored.

Needless to say, the application controller 511 may allow only the broadcast advertisement program to be displayed, or may allow only the broadcast advertisement program to be stored as necessary. Also, the application controller 511 does not decide to output or store the broadcast advertisement program, determines the broadcast advertisement program type, such that it can allow only the user-desired broadcast advertisement program to be displayed or stored. The application controller 511 may prevent only the broadcast advertisement program undesired by the user from being displayed, or may prevent only the broadcast advertisement program undesired by the user from being stored.

Fourth Preferred Implementation

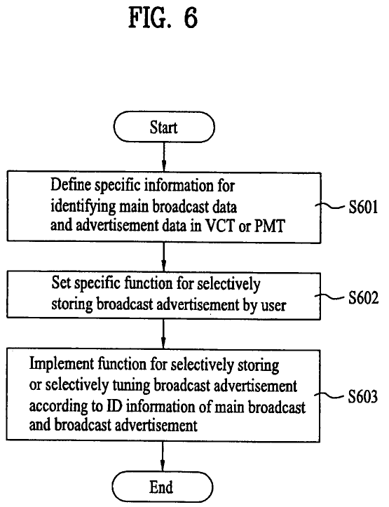

FIG. 6 is a flow chart illustrating a method for controlling a broadcast receiver for receiving a Program Map Table (PMT) or Virtual Channel Table (VCT) of a PSI/PSIP (Program Specific Information/Program and System Information Protocol), and processing the received PMT or VCT according to the present implementation.

A method for controlling the broadcast receiver according to the fourth preferred example of the present implementation will hereinafter be described with reference to FIG. 6 and FIGS. 1-5.

Referring to FIG. 6, the broadcast receiver receives the VCT or PMT at step S601. In this case, the VCT or PMT includes ID information for identifying the main broadcast program and the broadcast advertisement program and specific information for defining type information of the broadcast advertisement program at step S601.

The PMT and VCT according to the present implementation can be easily understood by the first and second preferred examples. The PMT and VCT are equal to those of the fourth preferred example of the present implementation.

A user allows a specific-type broadcast advertisement program to be additionally processed by the broadcast receiver by pressing a remote-controller or local-key button at step S602.

If the specific-type broadcast advertisement program established by the user is outputted by the PMT or VCT periodically received, the broadcast receiver tunes the specific-type broadcast advertisement program to another channel, or prevents specific-type broadcast advertisement program from being recorded at step S603.

It should be noted that most terminology disclosed in the present implementation is defined in consideration of functions of the present implementation, and can be differently determined according to application of those skilled in the art or usual practices. Therefore, it is preferable that the above-mentioned terminology be understood on the basis of all contents disclosed in the present implementation.

As apparent from the above description, a broadcast receiver according to the present implementation receives broadcast data including specific information capable of more precisely defining broadcast advertisement type information using a table of a specific PSI/PSIP, and controls the received broadcast data. The broadcast receiver automatically excludes broadcast advertisement data while a broadcast program of a specific time zone is recorded, extracts only the broadcast program, and stores the extracted broadcast program.

Other implementations are within the scope of the following claims. The details of one or more implementations are set forth in the accompanying drawings and the description below. Other features will be apparent from the description and drawings, and from the claims.

What is claimed is:

1. A method for processing a broadcast signal including a table of a Program Specific Information (PSI) or Program and System Information Protocol (PSIP) comprising:
receiving a broadcast signal including identifier (ID) information for identifying broadcast advertisement data;
detecting the ID information from the received broadcast signal; and
controlling the broadcast advertisement data whether or not to be stored in a memory the base on detected ID information.

2. The method according to claim 1, wherein the ID information is extracted from either a content-type field or a descriptor of the PSI and PSIP tables.

3. The method according to claim 2, wherein the content-type field including the ID information is transmitted along with a PCR_PID field.

4. The method according to claim 2, wherein the content-type field including the ID information is transmitted along with at least one of a “major_channel_number” field, a “minor_channel_number” field, a “carrier_frequency” field, a “program_number” field, and a “source_id” field.

5. A method for processing a broadcast signal including a table of a Program Specific Information (PSI) or Program and System Information Protocol (PSIP) comprising:
receiving a broadcast signal including both identifier (ID) information for identifying broadcast advertisement data and broadcast advertisement type information for defining type information of the broadcast advertisement data;
detecting the ID information from the broadcast advertisement type information from the received broadcast signal; and
controlling specific-type broadcast advertisement data whether or not to be stored in a memory the base on the detected ID information and the broadcast advertisement type information.

6. The method according to claim 5, wherein the ID information and the broadcast advertisement type information are extracted from either a content-type field or a descriptor of the PSI and PSIP tables.

7. The method according to claim 6, wherein the content-type field including the ID information and the broadcast advertisement type information is transmitted along with a PCR_PID field.

8. The method according to claim 6, wherein the content-type field including the ID information and the broadcast advertisement type information is transmitted along with at least one of a “major_channel_number” field, a “minor_channel_number” field, a “carrier_frequency” field, a “program_number” field, and a “source_id” field.

9. The method according to claim 5, wherein the specific type is established by a user.

10. A broadcast receiver comprising:
a tuner for receiving a broadcast signal including identifier (ID) information for identifying broadcast advertisement data;
a detector for extracting the ID information from the received broadcast signal; and
a controller for allowing the broadcast advertisement data whether or not to be stored in a memory the base on the detected ID information.

11. The broadcast receiver according to claim 10, wherein the detector extracts the ID information from either a content-type field or a descriptor of a Program Specific Information (PSI) and Program and System Information Protocol (PSIP) tables.

12. The broadcast receiver according to claim 10, wherein the controller allows specific-type broadcast advertisement data established by a user to be stored in the memory.

13. A broadcast receiver comprising:
a tuner for receiving a broadcast signal including identifier (ID) information for identifying broadcast advertisement data and broadcast advertisement type information for defining type information of the broadcast advertisement data;
a detector for extracting the ID information and the broadcast advertisement type information from the received broadcast signal; and
a controller for allowing the broadcast advertisement data whether or not to be stored in a memory the base on the detected ID information and broadcast advertisement type information.

14. The broadcast receiver according to claim 13, wherein the detector extracts the ID information and the broadcast advertisement type information from either a content-type field or a descriptor of a Program Specific Information (PSI) and Program and System Information Protocol (PSIP) table.

15. The broadcast receiver according to claim 13, wherein the controller allows specific-type broadcast advertisement data established by a user to be stored in the memory.
